(19) United States
(12) Patent Application Publication
(10) Pub. No.: US 2022/0284462 A1
(43) Pub. Date: Sep. 8, 2022

(54) APPARATUS FOR PROVIDING BENEFIT INFORMATION OF PAYMENT METHOD AND METHOD THEREOF

(71) Applicant: Coupang Corp., Seoul (KR)

(72) Inventors: Zee Young Min, Seoul (KR); Gyu Cheol Park, Seoul (KR); Seon Ryong Jo, Seoul (KR)

(21) Appl. No.: 17/202,152

(22) Filed: Mar. 15, 2021

(30) Foreign Application Priority Data
Mar. 5, 2021 (KR) 10-2021-0029303

(51) Int. Cl. G06Q 30/02; G06Q 20/22

(52) U.S. Cl. CPC G06Q 30/0222; G06Q 20/227; G06Q 30/0219; G06Q 30/0239

(57) ABSTRACT

Disclosed is a method of providing information by an electronic apparatus, the method including acquiring information on an item selected by a user, acquiring account information of the user including information on a plurality of payment methods registered by the user, acquiring benefit information related to a payment of the item with respect to at least one payment method among the plurality of payment methods, and providing information on a first payment method selected from the plurality of payment methods based on benefit information of the at least one payment method and first benefit information provided in association with the first payment method.

### BACKGROUND

### Technical Field

The present disclosure relates to a method and apparatus for providing benefit information of a payment method. More particularly, the present disclosure relates to an apparatus that acquires benefit information of at least one payment method in association with a payment of an item selected by a user and provides information on or regarding a first payment method selected based on the acquired benefit information of the at least one payment method and first benefit information provided in association with the first payment method, and a method thereof.

### Description of the Related Art

With the development of electronic technology, e-commerce has become a common type of shopping. A customer may purchase an item online without needing to go to a shopping mall or market in person. The item purchased online is delivered to a delivery destination requested by the customer.

As for the process of e-commerce, a user may shop for items that are on sale through a terminal connected to the Internet, such as a computer, and may transmit an intention to purchase items to a seller. In this case, the transaction related to the purchase of items may be processed by a payment method input by the user, such as a credit card number or a password.

When purchasing an item online, a customer may receive different benefits based on a payment method used for the purchase. For example, by performing a payment using a specific payment method, benefits such as a discount or point reward for a payment amount for an item may be provided.

However, in some cases, a user may not be aware of a benefit that the user can receive when performing the payment using the specific payment method. Also, in some cases, a user may not be specifically aware of the best benefit that the user can receive among benefits provided in association with payment methods and thus, may perform the payment using another payment method. Accordingly, it is required to recommend a payment method to the user and provide benefit information of the corresponding payment method.

In relation to this, related art documents such as KR20140023815A and KR20090063037A may be referenced.

### SUMMARY

### Technical Goals

An aspect provides a method and apparatus for acquiring benefit information of at least one payment method for a payment of an item selected by a user and providing information on or regarding a first payment method selected based on the acquired benefit information of the at least one payment method and first benefit information provided in association with the first payment method.

The goals to be achieved by example embodiments of the present disclosure are not limited to the objectives described above and other objects may be inferred from the following example embodiments.

### Technical Solutions

According to an aspect, there is provided a method of providing information by an electronic apparatus, the method including acquiring information on an item selected by a user, acquiring account information of the user including information on a plurality of payment methods registered by the user, acquiring benefit information related to a payment of the item with respect to at least one payment method among the plurality of payment methods, and providing information on a first payment method selected from the plurality of payment methods based on benefit information of the at least one payment method and first benefit information provided in association with the first payment method.

The first payment method may be selected based on a discount amount according to the first benefit information.

The method may further include processing, when a payment request for the item is received, data for performing a payment of the item based on the first payment method.

The acquiring of the benefit information may include determining benefit information related to a payment of the item based on at least one of the information on the item and the account information of the user.

The account information of the user may include at least one of details information on a payment made by the user for each of the plurality of payment methods and information on whether the user has signed up for a membership.

The membership may include a first membership corresponding to at least one of the plurality of payment methods and a second membership corresponding to a service corresponding to the electronic apparatus.

The providing of the first benefit information may include selecting the first payment method based on details information on a payment made by the user for each of the plurality of payment methods.

The method may further include providing, when details of a payment made by the user using a specific payment method included in the plurality of payment methods satisfy a first condition set in advance, information suggesting a use of the specific payment method.

The benefit information may include information applied for payment of the item among benefit information received from at least one server corresponding to each of the at least one payment method.

The method may further include acquiring event information provided for a preset period of time from at least one server corresponding to each of the at least one payment method. The first payment method may be selected based on the event information.

When a specific payment method previously selected for a purchase of the item is present, the providing of the first benefit information may include providing, when the specific payment method corresponds to a payment method different from the first payment method, information that compares the first benefit information and benefit information provided in association with the specific payment method.

A method in which the first benefit information and the benefit information provided in association with the specific payment method are provided may be determined based on a result of comparison between the first benefit information and the benefit information provided in association with the specific payment method.

The method may further include providing, when an input corresponding to the information on the first payment method is received from the user, a payment page of the item including a price to which the first benefit information is applied.

The providing of the first benefit information may include acquiring a balance of a budget assigned for providing the first benefit information and providing, when the balance satisfies a second condition set in advance, the information on the first payment method to the user. When the balance does not satisfy the second condition, the information related to the first payment method may not be provided to the user.

The method may further include providing information on a second payment method among the at least one payment method and second benefit information provided in association with the second payment method. A method in which the first benefit information and the second benefit information are provided may be determined based on a result of comparison between the first benefit information and the second benefit information.

According to another aspect, there is also provided an electronic apparatus for providing information, the electronic apparatus including a transceiver, a memory in which instructions are stored, and a processor, wherein the processor is connected to the transceiver and the memory to acquire information on an item selected by a user, acquire account information of the user including information on a plurality of payment methods registered by the user, acquire benefit information related to a payment of the item with respect to at least one payment method among the plurality of payment methods, and provide information on a first payment method selected from the plurality of payment methods based on benefit information of the at least one payment method and first benefit information provided in association with the first payment method.

Details of other example embodiments are included in the following detailed description and the accompanying drawings.

### Effects

According to example embodiments, a method and apparatus for providing benefit information of a payment method may recommend a specific payment method to a user and provide benefit information provided in association with the corresponding payment method, thereby inducing the user to perform a payment using a best payment method.

Effects of the present disclosure are not limited to those described above and other effects may be made apparent to those skilled in the art from the following description.

### BRIEF DESCRIPTION OF THE DRAWINGS

FIG. 1 is a diagram illustrating a system for providing benefit information of a payment method according to an example embodiment.

FIG. 2 is a flowchart illustrating a method of providing information by an electronic apparatus in a system for providing benefit information of a payment method according to an example embodiment.

FIG. 3 is a diagram illustrating an example in which an electronic apparatus receives benefit information from at least one server according to an example embodiment.

FIG. 4 is a diagram illustrating an example in which an electronic apparatus receives benefit information from at least one server according to an example embodiment.

FIG. 5 is an exemplary diagram illustrating an operation of an electronic apparatus providing benefit information of a first payment method according to an example embodiment.

FIG. 6 is an exemplary diagram illustrating an operation of an electronic apparatus receiving a payment request for an item according to an example embodiment.

FIG. 7 is an exemplary diagram illustrating an operation of an electronic apparatus selecting a first payment method based on details information of a payment made by a user for each of a plurality of payment methods according to an example embodiment.

FIG. 8 is an exemplary diagram illustrating an operation of an electronic apparatus providing information suggesting a use of a specific payment method according to an example embodiment.

FIG. 9 is an exemplary diagram illustrating an operation of an electronic apparatus providing an item search result corresponding to a search input of a user according to an example embodiment.

FIG. 10 is a diagram illustrating an example of an electronic apparatus for processing item sales information according to an example embodiment.

### DETAILED DESCRIPTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

The expression “at least one of A, B, and C” may include the following meanings: A alone; B alone; C alone; both A and B together; both A and C together; both B and C together; and all three of A, B, and C together.

In the present disclosure, a “terminal” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, example embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described with reference to the drawings.

In describing the example embodiments, descriptions of technical contents that are well known in the art to which the present disclosure belongs and are not directly related to the present specification will be omitted. This is to more clearly communicate without obscure the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

At this point, it will be understood that each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus the computer usable or computer readable memory. It is also possible for the instructions stored in to produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

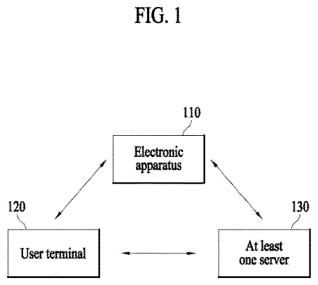

FIG. 1 is a diagram illustrating a system for providing benefit information of a payment method according to an example embodiment.

According to example embodiments, a system 100 for providing benefit information of a payment method may include an electronic apparatus 110, a user terminal 120, and at least one server 130. In some example embodiments, the system 100 may further include a server managed in a fulfillment center (hereinafter, referred to as a “fulfillment center server”). In some example embodiments, the system 100 may further include a network that supports data transmission and reception performed between at least some of the electronic apparatus 110, the user terminal 120, and the at least one server 130. In the example embodiments, the fulfillment center server may be a server that integrally manages a plurality of fulfillment centers or a system in which servers of respective fulfillment centers are connected through a network.

Each of the electronic apparatus 110, the user terminal 120, the at least one server 130, and the fulfillment center server may include a transceiver, a memory, and a processor. In addition, each of the electronic apparatus 110, the user terminal 120, the at least one server 130, and the fulfillment center server may be a unit that processes at least one function or operation, which may be implemented by hardware or software, or a combination of hardware and software. Meanwhile, in the overall example embodiments, the electronic apparatus 110, the user terminal 120, the at least one server 130, and the fulfillment center server are referred to as separate devices or servers, but they may be logically divided structures and implemented as separate functions in a single server. Depending on embodiments, the at least one server 130 may correspond to a single server and may also correspond to a plurality of servers. A description of the at least one server 130 will be given later in greater detail.

According to an example embodiment, the electronic apparatus 110, the user terminal 120, the at least one server 130, and the fulfillment center server may include a plurality of computer systems implemented as network servers or computer software. For example, at least some of the electronic apparatus 110, the user terminal 120, the at least one server 130, and the fulfillment center server may refer to a computer system and computer software connected to a lower level device capable of communicating with another network server through a computer network such as an intranet or the Internet to receives a request to perform a task, performs the task, and provides a result of the task. In addition, at least some of the electronic apparatus 110, the user terminal 120, the at least one server 130, and the fulfillment center server may be understood as broad concepts including a series of application programs that can operate on a network server and various databases built therein. At least some of the electronic apparatus 110, the user terminal 120, the at least one server 130, and the fulfillment center server may be implemented using a network server program that is provided in various ways based on an operating system such as DOS, Windows, Linux, UNIX, or MacOS, for example.

The electronic apparatus 110 may be an apparatus that manages a website to provide an e-commerce service online. The electronic apparatus 110 may configure various information into a web page and provide the web page to the user terminal 120. Specifically, the electronic apparatus 110 may be an apparatus that serves to provide various information associated with item selling to the user terminal 120.

The electronic apparatus 110 acquires information on or regarding an item selected by a user and acquires account information of the user. The account information of the user includes information on a plurality of payment methods registered by the user. The information on the item acquired by the electronic apparatus 110 may be information input through the user terminal 120. The account information acquired by the electronic apparatus 110 may be information stored in advance in the electronic apparatus 110 or information input through the user terminal 120.

The electronic apparatus 110 acquires benefit information related to a payment of the item with respect to at least one payment method among the plurality of payment methods. At least a portion of the acquired benefit information may be associated with benefit information received from the at least one server 130. At least a portion of the acquired benefit information may include benefits provided on a website managed by the electronic apparatus 110. At least a portion of the acquired benefit information may be stored in advance in the electronic apparatus 110.

The acquired benefit information may include a price discount benefit or point reward benefit related to an item purchase. In some cases, the benefit information may be information limited to a benefit related to a purchase of a specific item selected by the user and may be information on benefits related to the purchase of various items without limiting to the specific item selected by the user.

The electronic apparatus 110 provides information on a first payment method selected from the plurality of payment methods based on benefit information of the at least one payment method and first benefit information provided in association with the first payment method. The first benefit information may correspond to benefits related to the purchase of the specific item selected by the user.

The electronic apparatus 110 may provide a payment page for purchase and payment of the item to the user. When an input corresponding to the information on the first payment method is received from the user, the electronic apparatus 110 may provide a payment page of the item including a price to which the first benefit information is applied. In some cases, even when an item purchase request that does not include separate payment method selecting information is received from the user terminal 120 (for example, when the user does not select a separate payment method), the electronic apparatus 110 may provide a payment page including a price to which the first benefit information provided by the first payment method is applied.

When a payment request for the item is received, the electronic apparatus 110 may process data for performing the payment of the item. In an example embodiment, even when an item purchase request that does not include separate payment method selecting information is received from the user terminal 120 (for example, when the user does not select a separate payment method), the electronic apparatus 110 may process the data for performing the payment of the item based on the first payment method. In this case, the payment may be performed based on a price to which the first benefit information is applied.

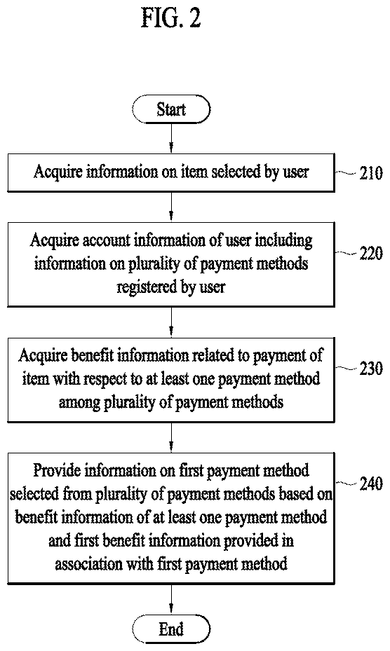

A method of providing information in the electronic apparatus 110 will be further described in greater detail with reference to FIG. 2.

The user terminal 120 may be a device used by the user to purchase an item through an e-commerce web site. The user terminal 120 may be implemented as a computer or a portable terminal for transmitting and receiving various information to and from the electronic apparatus 110 through a network. The user terminal 120 may provide the information received from the electronic apparatus 110 to the user, receive an input from the user, and transmit the input to the electronic apparatus 110. Specifically, the user terminal 120 may receive an input of a user selecting an item and transfer information on the item to the electronic apparatus 110. In some cases, the user terminal 120 may transfer the account information of the user to the electronic apparatus 110. In addition, the user terminal 120 may receive the information on the first payment method and the first benefit information provided in association with the first payment method from the electronic apparatus 110 and provide the received information and first benefit information on a screen. Further, in response to a purchase request being received from the user, the user terminal 120 may transfer the purchase request to the electronic apparatus 110, provide the payment page provided by the electronic apparatus 110 on the screen, or transfer a payment request from the user to the electronic apparatus 110. As such, the user terminal 120 may perform an operation related to data transmission and reception between the user and the electronic apparatus 110.

The input received from the user may include various types of inputs, for example, click applied using a mouse, touch applied using a touchpad or a touch screen, voice recognition, and other electrical inputs.

The fulfillment center server may refer to a server managed in a fulfillment center for storing and delivering items sold online. In response to a shipping and delivery request being received, the fulfillment center server may proceed with shipping at least some of the items and prepare delivery. The fulfillment center server may perform a process for shipping an item and delivering the item to an address received from the electronic apparatus 110. In addition, the fulfillment center server may manage stock of the fulfillment center and perform an operation such as checking a work status of personnel related to shipping and delivery to complete item delivery within a predetermined period of time without omission. Also, in some cases, the fulfillment center server may further check whether the item is paid in the at least one server 130.

The at least one server 130 may be one or more servers corresponding to each of at least one payment methods. The at least one server 130 may include a server corresponding to the first payment method. According to an example embodiment, each of the at least one server 130 may correspond to a server managed by a specific financial institution. For example, a specific server included in the at least one server 130 may correspond to a server managed by XX bank. According to an example embodiment, the benefit information related to the payment of the item may be benefits provided at the at least one server 130.

According to an example embodiment, the plurality of payment methods may include a transfer of payment amount based on an account managed by the at least one server 130. According to an example embodiment, the plurality of payment methods may include a payment using a card issued by a card company corresponding to the at least one server 130. According to an example embodiment, the plurality of payment methods may include a mobile phone payment. In addition, the plurality of payment methods is not limited to a specific method and includes various payment methods.

The at least one server 130 may transmit the benefit information related to the payment method to the electronic apparatus 110.

The network may serve to connect the electronic apparatus 110 and the user terminal 120, the fulfillment center server, the at least one server 130, or other external devices. For example, the network may provide an access path so that the user terminal 120 is connected to the electronic apparatus 110 to transmit and receive packet data to and from the electronic apparatus 110.

A series of operations related to a method for processing item sale information according to various example embodiments may be implemented by a single physical device, or may be implemented by a plurality of physical devices combined organically. For example, some of the components included in the system 100 may be implemented by any one physical device, and the remaining components may be implemented as another physical device. For example, one physical device may be implemented as a part of the electronic apparatus 110, and another physical device may be implemented as a part of the user terminal 120, a part of the fulfillment center server, a part of the at least one server 130, or a part of an external device. In some cases, components included in the system 100 may be distributed and arranged in different physical devices. The distributed components may be organically combined to perform functions and operations of the system 100. For example, the electronic apparatus 110 of the present disclosure may include at least one sub-device. Some operations described as being performed by the electronic apparatus 110 may be performed by a first sub-device, and some other operations may be performed by a second sub-device.

FIG. 2 is a flowchart illustrating a method of providing information by an electronic apparatus in a system for providing benefit information of a payment method according to an example embodiment.

Referring to FIG. 2, in operation 210, the electronic apparatus 110 according to an example embodiment acquires information on an item selected by a user. In operation 220, the electronic apparatus 110 acquires account information of the user including information on a plurality of payment methods registered by the user. As described above, the information on the item acquired by the electronic apparatus 110 may be information input through the user terminal 120. Also, the account information acquired by the electronic apparatus 110 may be information stored in advance in the electronic apparatus 110 or information input through the user terminal 120.

The account information of the user may include at least one of details information on a payment made by the user for each of the plurality of payment methods and information on whether the user has signed up for membership. The information on whether the user has signed up for a membership may include at least one of information on whether the user has signed up for a first membership corresponding to at least one of the plurality of payment methods and information on whether the user has signed up for a second membership corresponding to a service corresponding to the electronic apparatus 110. In this case, the first membership may be a membership provided at a server that manages a corresponding payment method. Also, the second membership may be a membership provided at the electronic apparatus 110. In some cases, the server that manages the payment method corresponding to the first membership may be included in the at least one server 130.

The electronic apparatus 110 may select the first payment method based on details information on a payment made by the user for each of the plurality of payment methods. Further, the electronic apparatus 110 may also select the first payment method based on the information on whether the user has signed up for the membership.

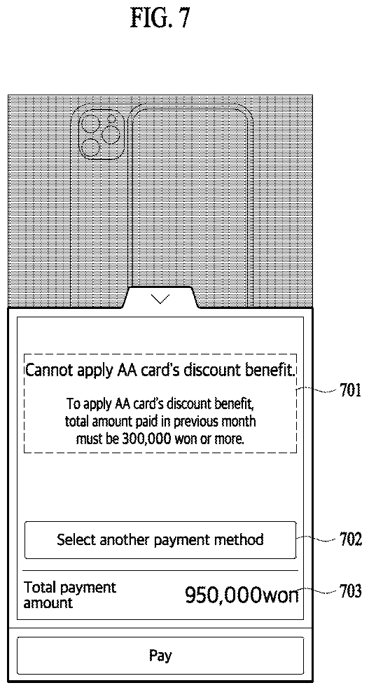

The electronic apparatus 110 selecting the first payment method based on details information on or regarding a payment made by the user for each of the plurality of payment methods will be further described in greater detail with reference to FIG. 7.

In operation 230, the electronic apparatus 110 acquires benefit information related to a payment of the item with respect to at least one payment method among the plurality of payment methods. As described above, at least a portion of the acquired benefit information may be associated with benefit information received from the at least one server 130. Also, at least a portion of the acquired benefit information may include benefits provided on a website managed by the electronic apparatus 110.

The electronic apparatus 110 may determine benefit information related to a payment of the item based on at least one of the information on the item and the account information of the user. Specifically, whether the benefit information corresponding to the payment method is to be provided may be determined based on the account information or determined according to the item selected by the user. Thus, the electronic apparatus 110 may determine the benefit information based on at least one of the information on the item and the account information of the user. In other words, the determined benefit information may include information applied for payment of the item among benefit information received from the at least one server 130. For example, benefit information provided in association with a specific payment method may correspond to a benefit of providing a 10% discount on the purchase of daily necessities online when the user does not have any overdue details regarding the corresponding payment method. In this example, the electronic apparatus 110 may determine the benefit information based on whether the item selected by the user belongs to the daily necessities and whether the user does not have overdue details.

According to an example embodiment, benefit information determined based on the item information or the account information of the user may be transmitted from at least a portion of the at least one server 130. In this case, depending on an embodiment, the electronic apparatus 110 may not need to determine the benefit information based on at least one of the information on the item and the account information of the user. However, in this case, the electronic apparatus 110 may have transmitted information related to the item selected by the user to at least a portion of the at least one server 130 before the benefit information is received.

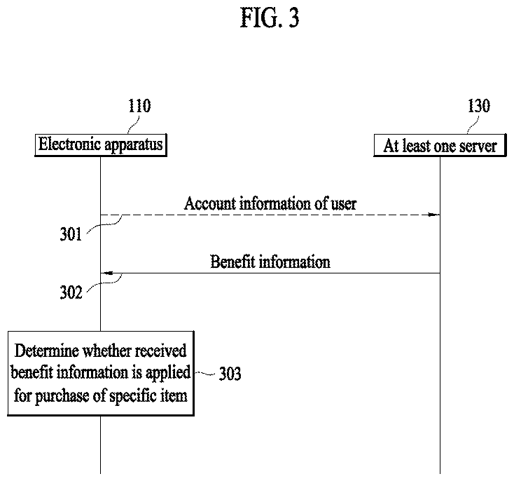

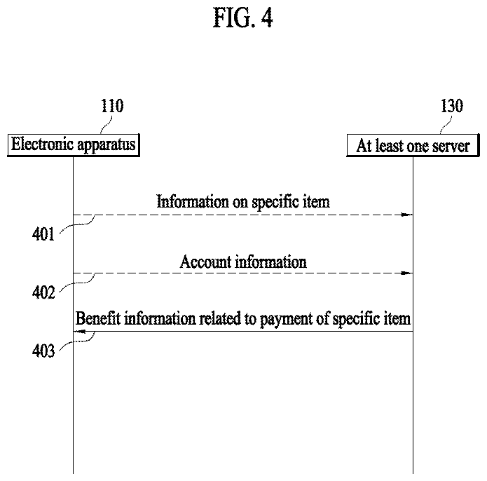

An example in which the electronic apparatus 110 receives benefit information from the at least one server 130 will be further described with reference to FIGS. 3 and 4.

In operation 240, the electronic apparatus 110 provides information on a first payment method selected from the plurality of payment methods based on benefit information of the at least one payment method and first benefit information provided in association with the first payment method. The first benefit information may correspond to benefits related to a purchase of a specific item selected by the user.

The first payment method may be selected based on a discount amount according to the first benefit information. In this case, among at least one payment method, a payment method that provides a greatest discount rate may be selected. In some embodiments, by comparing not only discount amounts of the payment of the item but also a point reward benefit corresponding to the payment method and a cashback benefit corresponding to the service corresponding to the electronic apparatus 110, a payment method determined to have the greatest benefit substantially may be selected as the first payment method. For example, when AA card provides a 100,000-won discount benefit and BB card provides a 200,000-point accumulating benefit, if it is determined that one point is worth more than 0.5 won, BB card may be selected as the first payment method. In this example, information related to a value of points or cash may be included in the information stored in advance in the electronic apparatus 110. In some cases, the information related to the value of points or cash may be included in the information received from the at least one server 130. The foregoing embodiment is merely an example of selecting the first payment method, and it is not necessary to select the payment method with the greatest discount rate or greatest benefit as the first payment method. For example, the first payment method may be selected according to an embodiment in which a payment method that provides a predetermined discount rate or more is selected.

According to an example embodiment, the electronic apparatus 110 may further acquire event information provided for a preset period of time from the at least one server 130. The event information may be transmitted from the at least one server 130 as an event related to a service corresponding to the at least one server 130 is held or an event plan is established. In some embodiments, the event information may be transmitted irrespective of a request from the electronic apparatus 110.

According to an example embodiment, a specific payment method that is selected in advance to purchase the item may be present. In this case, an input of selecting the specific payment method may be received along with an input of a user selecting an item. Alternatively, the specific payment method may correspond to a payment method set in advance as a default payment method in association with an item purchase of the user.

When the selected specific payment method is present, and when the specific payment method corresponds to a payment method different from the first payment method, the electronic apparatus 110 may provide information that compares the first benefit information and benefit information provided in association with the specific payment method. For example, when the specific payment method is BB card that provides a 10% discount, and when the first payment method is AA card that provides a 12% discount, the electronic apparatus 110 may provide comparison information including text such as “Use your AA card for payment and get 2% more discount compared to BB card.”

In some embodiments, the electronic apparatus 110 may determine a method in which the first benefit information and the benefit information provided in association with the specific payment method are provided, based on a result of comparison between the first benefit information and the benefit information provided in association with the specific payment method. For example, the specific payment method may be AA card that provides a 10% discount and the first payment method may be BB card that provides a 12% discount. In this example, since the benefit corresponding to the first payment method provides a higher discount rate, benefit information corresponding to the first payment method may be displayed in an upper portion of a screen of the user terminal 120 and benefit information corresponding to the specific payment method may be displayed below the benefit information corresponding to the first payment method.

According to an example embodiment, in addition to the first payment method, the electronic apparatus 110 may further provide information on or regarding another payment method and first benefit information provided in association with the corresponding payment method. For example, the electronic apparatus 110 may further provide information on a second payment method among the at least one payment method and second benefit information provided associated with the second payment method. In this case, like the example embodiment related to the specific payment method described above, a method in which the first benefit information and the second benefit information are provided may be determined based on a result of comparison between the first benefit information and the second benefit information. As an example, the user terminal 120 may display information on a plurality of different benefits in descending order of their actual benefits (the actual benefits may correspond to values obtained by calculating various benefits such as discount benefit, point award benefit, cashback benefit, free gift benefit, and the like according to a preset actual value ratio). As another example, the electronic apparatus 110 may provide the first benefit information corresponding to the first payment method at the top and provide other benefit information in the descending order of actual benefits. In addition, a method in which the information on the plurality of different benefits is provided may be determined based on various references.

According to an example embodiment, the electronic apparatus 110 may acquire a balance of a budget assigned for providing the first benefit information. When the balance satisfies a second condition set in advance, the electronic apparatus 110 may provide the information on the first payment method to the user. The second condition may correspond to a case in which the balance of the budget assigned for providing the first benefit information is sufficient to provide the first benefit information. When the balance does not satisfy the second condition, the electronic apparatus 110 may not provide the information related to the first payment method to the user. For example, the first benefit information may correspond to a benefit of discounting 10% of a payment amount when a specific item is paid using AA card in AA card company. In this example, when AA card company has funded 100 million won as a budget to provide the benefit, the electronic apparatus 110 may check a balance of the budget in advance to provide the information on the first payment method to the user. For example, when a price of the specific item is one million won, and when a payment input for 100 items is applied along with an input of selecting the specific item, a balance of the assigned budget may be greater than or equal to 10 million won that is a value calculated according to (1 million won/each)*(100 items)*(10/100).

FIG. 3 is a diagram illustrating an example in which an electronic apparatus receives benefit information from at least one server according to an example embodiment.

Referring to FIG. 3, in operation 302, the electronic apparatus 110 according to an example embodiment receives benefit information from the at least one server 130. According to an example embodiment, in operation 301, the electronic apparatus 110 may transmit account information of a user to at least a portion of the at least one server 130 before the benefit information is received. In this case, at least a portion of the at least one server 130 may transmit the benefit information based on the account information of the user. For example, among benefit information provided from the at least one server 130, information on unavailable benefits may not be transmitted to the user.

In response to the benefit information being received, in operation 303, the electronic apparatus 110 may determine whether the received benefit information is applied for a purchase of a specific item (for example, an item selected by the user). Further, the electronic apparatus 110 may further determine whether the received benefit information is information on a benefit available for the item purchase of the user in consideration of the account information of the user.

FIG. 4 is a diagram illustrating an example in which an electronic apparatus receives benefit information from at least one server according to an example embodiment.

Referring to FIG. 4, in operation 401, the electronic apparatus 110 according to an example embodiment may transmit information on a specific item (for example, an item selected by a user) to at least a portion of the at least one server 130. In this case, at least a portion of the at least one server 130 may transmit benefit information based on the information on the specific item. For example, among benefit information provided from the at least one server 130, information on a benefit unable to be applied to the item selected by the user may not be transmitted.

According to the example embodiment, in operation 402, the electronic apparatus 110 may transmit account information of the user to at least a portion of the at least one server 130 before the benefit information is received. In this case, at least a portion of the at least one server 130 may transmit the benefit information based on the account information of the user.

When the information on the specific item is transmitted to each of the at least one server 130, it can be expected that benefits unable to apply to the specific item have been excluded by the at least one server 130. Thus, the electronic apparatus 110 may not need to determine benefit information by considering the information on the item. Also, when the account information of the user is transmitted to each of the at least one server 130, it can be expected that benefits unable to apply to the specific item have been excluded by the at least one server 130. Thus, the electronic apparatus 110 may not need to determine benefit information by considering the account information of the user.

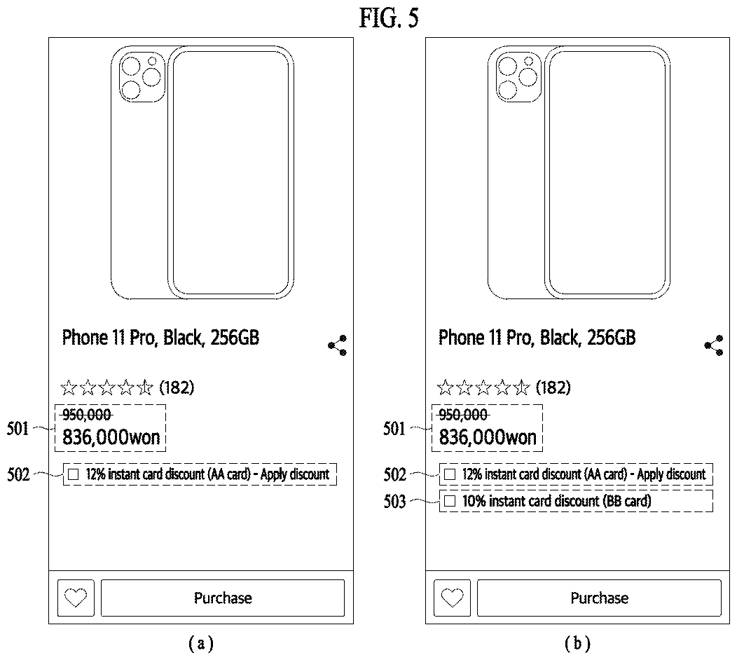

FIG. 5 is an exemplary diagram illustrating an operation of an electronic apparatus providing benefit information of a first payment method according to an example embodiment.

Referring to FIG. 5, the electronic apparatus 110 according to an example embodiment may provide first benefit information provided in association with a first payment method to the user terminal 120. The user terminal 120 may output the received first benefit information. The first benefit information may be included in an item search result and provided, included in item details information and provided, or included in an item payment page and provided.

The benefit information of the first payment method may include a text, for example, “12% of card instant discount (AA card)” as indicated by a dashed box 502. Further, as indicated by a dashed box 501, a page in which the first benefit information is displayed may include a price to which the first benefit information is applied. According to an example embodiment, the page in which the first benefit information is displayed may include a price before the first benefit information is applied and the price to which the first benefit information is applied, such as “836,000 won.”

In some cases, the electronic apparatus 110 may further provide, to the user terminal 120, benefit information provided in association with a specific payment method that is previously selected to purchase an item, or second benefit information provided in association with a second payment method included in at least one payment method. In such cases, as described above, the user terminal 120 may display information on a plurality of different benefits in descending order of their actual benefits. For example, when the specific payment method is BB card that provides a 10% discount, and when the first payment method is AA card that provides a 12% discount, the user terminal 120 may display benefit information of AA card above and display benefit information of BB card therebelow as indicated by a dashed box 503.

Further, in an example embodiment, the electronic apparatus 110 may provide information that compares information on or regarding a plurality of different benefits. The user terminal 120 may display the comparison information received. The comparison information may include, for example, a text such as “Use AA card for payment and get 2% more discount compared to BB card.”

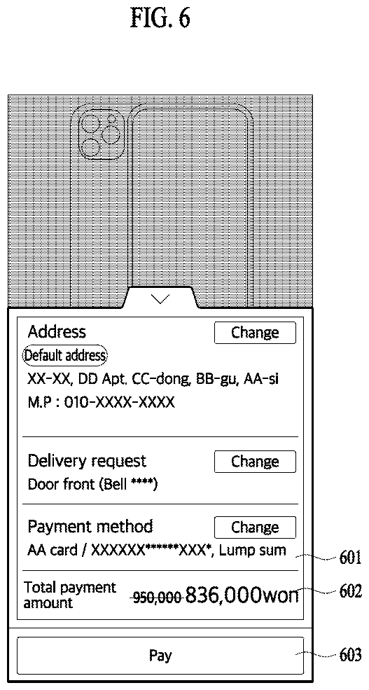

FIG. 6 is an exemplary diagram illustrating an operation of an electronic apparatus receiving a payment request for an item according to an example embodiment.

Referring to FIG. 6, the electronic apparatus 110 according to an example embodiment may receive a payment request for an item and process data for performing a payment of the item. An example of the payment request for the item may correspond to receiving an input corresponding to information on a first payment method. In this case, the electronic apparatus 110 may provide a payment page in which the first payment method is selected as a payment method as indicated by reference numeral 601.

The payment page provided by the electronic apparatus 110 may include a price to which the first benefit information is applied as indicated by reference numeral 602. According to an example embodiment, the payment page may include an item price before a first benefit is applied and an item price to which the first benefit is applied, such as “836,000 won.”

The payment page may further include a user interface (UI) 603 for receiving a final payment request input of a user. When the final payment request input of the user is received, the electronic apparatus 110 may transmit a request to a server corresponding to the first payment method to pay the price of the item. Further, when an item selected by the user is an item to be delivered, the electronic apparatus 110 may transmit a shipping and delivery request for the item to the fulfillment center server.

FIG. 7 is an exemplary diagram illustrating an operation of an electronic apparatus selecting a first payment method based on details information of a payment made by a user for each of a plurality of payment methods according to an example embodiment.

The electronic apparatus 110 may select a first payment method based on details information on a payment made by a user for each of a plurality of payment methods. Specifically, irrespective of a comparison result of benefit information, if the details information on the payment made by the user needs to satisfy a predetermined condition in order to provide the benefit information, the electronic apparatus 110 may further determine whether the corresponding condition is satisfied and select the first payment method. According to an example embodiment, the predetermined condition may correspond to whether a total amount of payment corresponding to a specific payment method is greater than a first threshold for a preset period of time to provide benefits. For example, to receive a discount benefit of AA card, a total amount paid in a previous month using the specific payment method may need to be 300,000 won or more.

In order to provide the benefit information, when the details information on the payment made by the user does not satisfy a predetermined condition, the electronic apparatus 110 may provide information indicating that the corresponding condition is not satisfied to the user terminal 120. The user terminal 120 may display the corresponding information on a payment page as indicated by a dashed box 701. For example, the information indicating that the corresponding condition is not satisfied may include, for example, a text such as “Cannot apply AA card's discount benefit. To apply AA card's discount benefit, total amount paid in previous month must be 300,000 won or more.”

According to the example embodiment, in order to provide the benefit information, when the details information on the payment made by the user does not satisfy a predetermined condition, the electronic apparatus 110 may further provide the user terminal 120 with a UI for receiving an input of selecting another payment method as indicated by a box 702. The UI for receiving an input of selecting another payment method may include, for example, a text such as “select another payment method.” In response to a user input to the UI being received, additional information for selecting a payment method different from the payment method corresponding to AA card may be further displayed.

According to the example embodiment, in order to provide the benefit information, when the details information on the payment made by the user does not satisfy a predetermined condition, the user terminal 120 may display an item price to which benefit is unapplied as indicated by reference numeral 703.

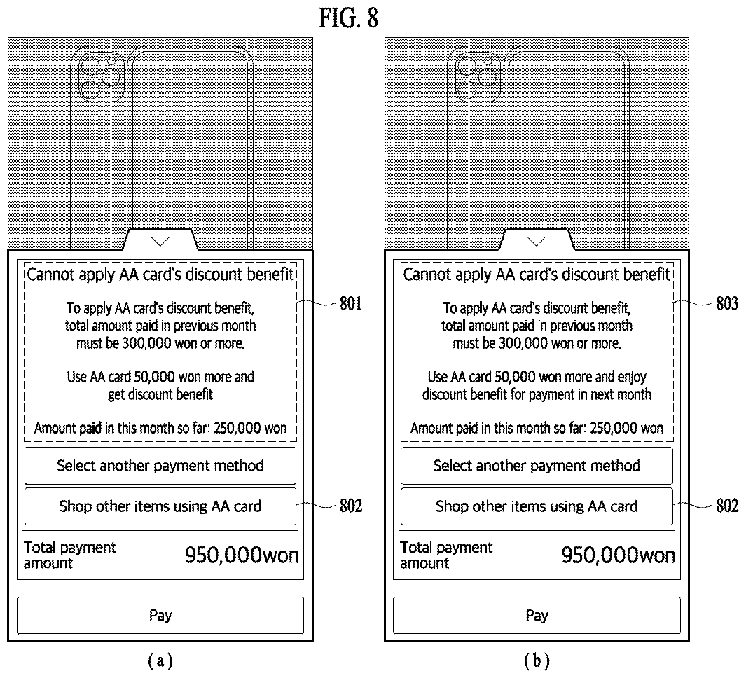

FIG. 8 is an exemplary diagram illustrating an operation of an electronic apparatus providing information suggesting a use of a specific payment method according to an example embodiment.

Referring to FIG. 8, the electronic apparatus 110 according to an example embodiment may suggest a use of a specific payment method. Specifically, when details of a payment made by a user using the specific payment method included in a plurality of payment methods satisfy a first condition set in advance, the electronic apparatus 110 may suggest the use of the corresponding payment method.

In this case, according to an example embodiment, the first condition may correspond to whether a condition for receiving benefit information is somewhat fulfilled, although the condition for receiving the benefit information has not been satisfied yet. For example, in order to receive the benefit information, a total amount of payment corresponding to the specific payment method may be greater than a first threshold for a preset period of time. In this example, the first condition may correspond to whether the total amount of payment corresponding to the specific payment method is less than the first threshold and greater than a second threshold for the preset period of time in order to provide benefits.

The electronic apparatus 110 may provide information including various contents to suggest a user to use a specific payment method. As an example, in order to receive discount benefits of AA card, a total payment amount of a current month may be over 300,000 won. In this example, if an amount paid using AA card in the current month so far is 250,000 won, the electronic apparatus 110 may provide information including the total payment amount for receiving the discount benefit of AA card, the amount used in the current month, and an amount required to be further paid to enjoy the discount benefit of AA card as indicated by a dashed box 801. As another example, in order to receive the discount benefit of AA card, a total amount paid in a previous month needs to be 300,000 won or more. In this example, if an amount paid using AA card in the current month so far may be 250,000 won, the electronic apparatus 110 may provide information including at least one of a total payment amount for receiving the discount benefit of AA card, the amount paid by the user in the current month, and an amount required to be further paid using AA card to enjoy the discount benefit in a next month as indicated by a dashed box 803. Information on or regarding such card usage records may be acquired from a server related to the corresponding card. Also, in the example embodiment, even before the information is acquired from a card server, the electronic apparatus 110 may identify records information of payments performed using the corresponding card in a service related to the electronic apparatus 110. When the records information satisfies a condition, the electronic apparatus 110 may determine that benefit corresponding to the card is applicable and provide the user with information corresponding thereto.

According to the example embodiment, in order to suggest the specific payment method to the user, the electronic apparatus 110 may further provide a UI for receiving an input for purchasing another item using the specific payment method as indicated by a box 802. The UI for receiving an input for purchasing another item may include, for example, a text such as “shop other items using AA card.”

According to the example embodiment, even when details of a payment made by the user using the specific payment method satisfies a preset first condition, the user may not use the corresponding payment method. In this case, the electronic apparatus 110 may further provide the user terminal 120 with a UI for receiving an input of selecting another payment method (corresponding to the box 702 of FIG. 7).

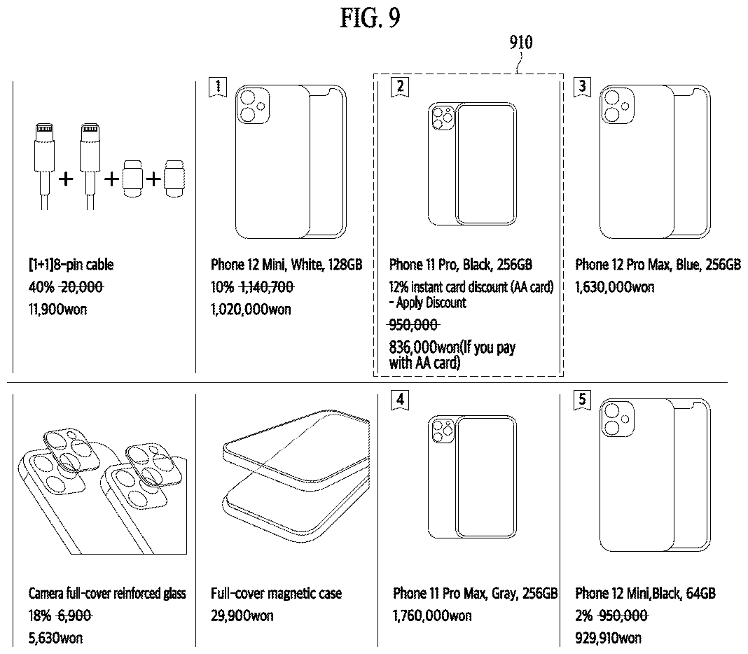

FIG. 9 is an exemplary diagram illustrating an operation of an electronic apparatus providing an item search result corresponding to a search input of a user according to an example embodiment.

Referring to FIG. 9, the electronic apparatus 110 according to an example embodiment may receive a search input of a user and provide an item search result corresponding to the search input of the user. In this case, the user may select an item based on the search result provided by the electronic apparatus 110.

The search result provided by the electronic apparatus 110 may include first benefit information or information on a price to which the first benefit information is applied. Specifically, when first benefit information provided in association with a first payment method is applicable to a first item included in the item search result, as indicated by a dashed box 910, the electronic apparatus 110 may provide at least one of the first benefit information and the information on the price to which the first benefit information is applied, in an area in which information associated with the first item is displayed. For example, the search result provided by the electronic apparatus 110 may include first benefit information including text like “instant card discount 12% (AA card)” and price information including text like “836,000 won (if you use AA card).”

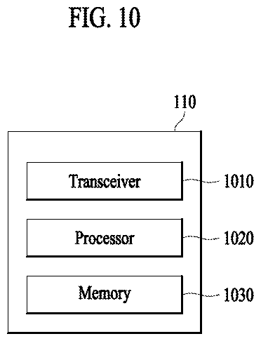

FIG. 10 is a diagram illustrating an example of an electronic apparatus for processing item sales information according to an example embodiment.

Referring to FIG. 10, the electronic apparatus 110 includes a transceiver 1010, a processor 1020, and a memory 1030. The electronic apparatus 110 is connected to the user terminal 120, the at least one server 130, a fulfillment center server, and other external devices through the transceiver 1010, and may perform data exchange.

The processor 1020 may include at least one of the devices described above with reference to FIGS. 1 through 9, or may perform at least one method described above with reference to FIGS. 1 through 9. The memory 1030 may store information for performing at least one method described above with reference to FIGS. 1 through 9. The memory 1030 may be a volatile memory or a nonvolatile memory.

The processor 1020 may execute a program and control the electronic apparatus 110 for providing information. The code of a program executed by the processor 1020 may be stored in the memory 1030.

Also, in an example embodiment, the electronic apparatus 110 may provide, to the user terminal 120, a UI for providing information to a user.

The present specification and drawings have been described with respect to the example embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

The electronic apparatus or terminal in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

1. A method operable by an electronic apparatus to provide information, the method comprising:
controlling, by a processor of the electronic apparatus, a transceiver of the electronic apparatus to communicate with a user device and a first server,
receiving, from the user device via the transceiver, information regarding an item selected by a user;
receiving, from the user device via the transceiver, account information of the user including information comprising a plurality of payment methods registered by the user;
receiving, from the first server via the transceiver, benefit information regarding the item with respect to at least one payment method among the plurality of payment methods;
selecting a first payment method by comparing benefit information of the at least one payment method;
generating first information comprising first benefit information provided in association with the first payment method;
generating, by the processor, a first user interface displaying an image of the item, and the first information; and
when a payment method pre-selected before the first payment method is selected is present and the pre-selected payment method is different from the first payment method, generating the first information comprises:
generating comparison information comparing the first benefit information and benefit information provided in association with the pre-selected payment method, wherein the comparison information comprises a result obtained by numerically calculating a difference between benefit provided in association with the first payment method and benefit provided in association with the pre-selected payment method.

2. The method of claim 1, wherein the at least one payment method is selected based on a discount amount according to the benefit information.

3. The method of claim 1, further comprising:
processing, in response to receiving a payment request, data for performing a payment of the item based on the at least one payment method.

4. The method of claim 1, wherein the receiving of the benefit information comprises:
determining benefit information related to a payment for the item based on at least one of: the information regarding the item or the account information of the user.

5. The method of claim 1, wherein the account information of the user comprises at least one of: details information regarding a payment made by the user for each of the plurality of payment methods or information regarding whether the user has signed up for a membership.

6. The method of claim 5, wherein the membership includes a first membership corresponding to at least one of: the plurality of payment methods or a second membership corresponding to a service corresponding to the electronic apparatus.

7. The method of claim 1, wherein the generating of the first user interface comprises displaying a first benefit information associated with a first payment method of the at least one payment method, wherein the first payment method is identified based on details information regarding a payment made by the user for each of the plurality of payment methods.

8. The method of claim 1, further comprising:
providing, in response to determining that details of a payment made by the user using a specific payment method of the plurality of payment methods satisfy a first predetermined condition, information suggesting a use of the specific payment method.

9. The method of claim 1, wherein the benefit information includes information applied for payment for the item among benefit information received from the first server corresponding to each of the at least one payment method.

10. The method of claim 1, further comprising:
acquiring event information provided for a preset period of time from the first server corresponding to each of the at least one payment method; and
providing a first payment method of the at least one payment method to the user device, wherein the first payment method is selected based on the event information.

11. (canceled)

12. The method of claim 1, wherein the first benefit information associated with the first payment method and the benefit information associated with the pre-selected payment method are provided based on a result of comparison between the first benefit information associated with the first payment method and the benefit information associated with the pre-selected payment method.

13. The method of claim 1, further comprising:
receiving, from the user device, an input corresponding to information regarding the at least one payment method; and
providing a payment page for the item including a price to which a first benefit information of the at least one payment method is applied.

14. The method of claim 1, further comprising providing, to the user device, a first payment method of the at least one payment method and first benefit method associated with the first payment method, wherein the providing of the first benefit information comprises:
acquiring a balance of a budget assigned for providing the first benefit information; and
providing, in response to determining that the balance satisfies a second condition set in advance, the information regarding the first payment method to the user device,
wherein, in response to determining that the balance does not satisfy the second condition, the information related to the first payment method is not provided to the user device.

15. The method of claim 1, further comprising:
providing, to the user device, a first payment method of the at least one payment method and first benefit method associated with the first payment method; and
providing information regarding a second payment method of the at least one payment method and second benefit information associated with the second payment method,
wherein the first benefit information and the second benefit information are provided based on a result of comparison between the first benefit information and the second benefit information.

16. A non-transitory computer-readable recording medium storing thereon computer-readable instructions that, when executed by a processor of an electronic apparatus, cause the processor to:
control a transceiver of the electronic apparatus to communicate with a user device and a first server,
receive, from the user device, information regarding an item selected by a user;
receive, from the user device, account information of the user including information comprising a plurality of payment methods registered by the user;
receive, from the first server, benefit information regarding the item with respect to at least one payment method among the plurality of payment methods;
select a first payment method by comparing benefit information of the at least one payment method;
generate first information comprising first benefit information provided in association with the first payment method;
generate a first user interface displaying an image of the item, and the first information; and
when a payment method pre-selected before the first payment method is selected is present and the pre-selected payment method is different from the first payment method, generating the first information comprises:
generate comparison information comparing the first benefit information and benefit information provided in association with the pre-selected payment method, wherein the comparison information comprises a result obtained by numerically calculating a difference between benefit provided in association with the first payment method and benefit provided in association with the pre-selected payment method.

17. An electronic apparatus for providing information, the electronic apparatus comprising:
a transceiver;
a memory in which instructions are stored; and
a processor,
wherein the processor is connected to the transceiver and the memory, and wherein the processor is configured to:
control the transceiver to communicate with a user device and a first server,
receive, from the user device, information regarding an item selected by a user;
receive, from the user device, account information of the user including information comprising a plurality of payment methods registered by the user;
receive, from the first server, benefit information regarding the item with respect to at least one payment method among the plurality of payment methods;
select a first payment method by comparing benefit information of the at least one payment method;
generate first information comprising first benefit information provided in association with the first payment method;
generate a first user interface displaying an image of the item and the first information; and
when a payment method pre-selected before the first payment method is selected is present and the pre-selected payment method is different from the first payment method, generating the first information comprises:
generate comparison information comparing the first benefit information and benefit information provided in association with the pre-selected payment method, wherein the comparison information comprises a result obtained by numerically calculating a difference between benefit provided in association with the first payment method and benefit provided in association with the pre-selected payment method.
